(19) United States
(12) Patent Application Publication
(10) Pub. No.: US 2022/0307844 A1
(43) Pub. Date: Sep. 29, 2022

(54) NAVIGATION ROUTE FOR A PLURALITY OF LOCATIONS BASED ON MULTIPLE STARTING POSITIONS

(71) Applicant: Angelika Moore, Kirkland, WA (US)

(72) Inventor: Angelika Moore, Kirkland, WA (US)

(21) Appl. No.: 17/211,688

(22) Filed: Mar. 24, 2021

(51) Int. Cl. G01C 21/34; G01C 21/36

(52) U.S. Cl. CPC G01C 21/343; G01C 21/3453; G01C 21/3691

(57) ABSTRACT

Navigation routes for a plurality of locations based on multiple starting positions. A method includes receiving a request from a user to visit a plurality of properties and calculating a time to visit each of the plurality of properties based on one or more of a scheduled open house, an existing property visitation schedule, or a preference of the user. The method includes identifying a user starting location associated with the user and an agent starting location associated with a real estate professional accompanying the user and generating one or more potential navigation routes for visiting each of the plurality of properties. The method includes selecting a lowest cost navigation route based on one or more of: travel time for the user and/or the real estate professional; or total distance traveled by the user and/or the real estate professional.

### TECHNICAL FIELD

The disclosure relates generally to computer-based navigation and specifically to calculating navigation routes for a plurality of locations.

### BACKGROUND

When a property is listed for sale, potential buyers and licensed real estate professionals seek access to the property to view the property. It can be challenging for potential buyers and real estate professionals to coordinate with the seller and with each other to gain access to the property. Further, the home showing process can be an inefficient use of time and resources. Real estate professionals and potential buyers typically drive separate vehicles when viewing properties together, and real estate professionals may drive a considerable distance to grant potential buyers access to homes that are near the potential buyers' current location. This is an inefficient use of time and resources and has a negative impact on the environment through excess use of energy and emission of pollution.

Some sellers have an analog lockbox and/or digital lockbox installed at the property such that real estate professionals can access a key to the property when the seller of the property or the seller's real estate professional are not present at the property. Some digital lockboxes are configured to authenticate persons and only provide access to the key to those people who can be authenticated as a licensed real estate professional. However, in some instances, it is desirable to provide safe and secure access to a potential buyer even when a real estate professional is not physically present.

In light of the foregoing, disclosed herein are systems, methods, and devices for remote authentication of a digital lockbox with a licensed real estate agent when the licensed real estate agent is not physically present near the digital lockbox.

### BRIEF DESCRIPTION OF THE DRAWINGS

Non-limiting and non-exhaustive implementations of the present disclosure are described with reference to the following figures, wherein like reference numerals refer to like parts throughout the various views unless otherwise specified. Advantages of the present disclosure will become better understood with regard to the following description and accompanying drawings where:

FIG. 1 is a schematic diagram of a system for facilitating communications between a remote authentication platform and an onsite lock device such as a digital lockbox;

FIG. 2 is a block diagram of components of a remote authentication platform;

FIG. 3 is a schematic diagram of a process flow for associating a scannable code with a user seeking access to a property;

FIG. 4 is a schematic diagram illustrating communications between a digital lockbox and a remote authentication server;

FIG. 5 illustrates an example map for identifying a navigation route between a plurality of properties with two independent starting locations;

FIG. 6 is a schematic flow chart diagram of a method for remote authorization of a user for unlocking an onsite lock device;

FIG. 7 is a schematic flow chart diagram of a method for generating a navigation route for visiting a plurality of properties from two or more independent starting locations; and

FIG. 8 illustrates components of an example computing device.

### DETAILED DESCRIPTION

Disclosed herein are systems, methods, and devices for remote authentication of a digital lockbox with a licensed real estate professional when the real estate professional is not physically present near the digital lockbox. The systems, methods, and devices described herein overcome numerous problems and inefficiencies associated with current real estate showing practices. Further disclosed herein are systems, methods, and devices for generating an efficient touring route for viewing real property. The touring route may include a plurality of real property locations and may consider the original locations of all parties when determining the most cost effective route.

A lockbox is a device for securely storing an item. Lockboxes are commonly used for securely storing a key. In some instances, a lockbox is located outside a building or secured room, and the lockbox securely stores a key for accessing the building or secured room. In such an instance, the lockbox may be opened to access the key, and then the building or secured room may be opened with the key. This can be useful where multiple different people need access to the key, or a person wishes to have a spare key for emergencies, or a person wishes to have a key securely located at the property. The lockbox itself may include a compartment for storing the key, and the compartment is securely closed when the lockbox is locked. The lockbox may be unlocked with a key, a combination using a rotary dial or series of buttons, a numerical code, an alphanumerical code, combination with key control, a digital unlocking mechanism, and so forth.

A digital lockbox is a lockbox that can be locked with a digital mechanism. A digital lockbox may additionally be unlocked with an analog mechanism such as a key, a combination, a numerical code, an alphanumerical code, and so forth. In an embodiment where the digital lockbox is unlocked with a digital mechanism, the digital lockbox may be unlocked by a digital keypad input, a voice input, a code scanner input, a voice activated device input, a computer-based application input, an indication received from a security or surveillance system, and so forth. A digital lockbox may be unlocked in response to a user entering a code with a digital interface. Further, a digital lockbox may be unlocked with a computer application, such as a smart phone application that may be in communication with a server by way of a network connection. In some embodiments, a digital lockbox is unlocked using a computer application, and the computer application is configured to permit only certain persons to unlock the digital lockbox. In such an embodiment, the computer application may be configured to permit, for example, licensed professionals or an enumerated listing of persons to unlock the lockbox. This can be particularly useful when a building is offered for sale and multiple real estate professionals seek access to the property for showings.

In some instances, a digital lockbox is located outside a property that is offered for sale. The property may include a residence, such as a single family home, a multiple family home, or other residence, or a commercial property, or undeveloped or partially developed land. The digital lockbox may securely store a key for accessing the property. The digital lockbox may be opened or unlocked using a computer application, and the computer application is configured to permit only licensed real estate professionals to open the lockbox. In such an embodiment, real estate professionals may bring clients to view the property and may open the lockbox to obtain the key for opening the property by interfacing with the digital lockbox using the computer application. This enables real estate professionals to access the property without first obtaining the key from the seller of the property. Additionally, this can enable real estate professional to access the property without scheduling an appointment to view the property or even interfacing with the seller of the property. Some digital lockboxes compile a timestamped listing of all persons who have opened the digital lockbox and presumably entered the property.

In some cases, it is important for a potential buyer to gain access to a property without a real estate professional physically present. Current lockbox systems do not permit this and will open only for licensed real estate professionals who are physically present at the property. In some cases, a real estate professional may drive a considerable distance to show a property to a potential buyer that is very close to the current location of the potential buyer. For example, the property may be a one-hour driving distance from the real estate professional and only five minutes away from the potential buyer. In this scenario, the potential buyer may wish to quickly view the property without waiting for the real estate professional. Further for example, a real estate professional may be unavailable to show a property due to time constraints, scheduling constraints, vacation, and so forth. This can place the potential buyer in jeopardy of losing the opportunity to place an offer on the property simply because the potential buyer cannot afford to wait for the real estate professional to be physically present at the property showing. Further, in many cases, potential buyers wish to view properties in private so they can speak freely about the property and make quick decisions without feeling pressure from a real estate professional. In each of these cases, there is a need for the potential buyer to tour the property without the real estate professional being physically present at the property.

Further, when a home is listed for sale, the home and the neighborhood are more vulnerable to theft and break ins. For example, when a property is listed on the market for sale, next door or near neighbors may assume that each person entering the home for sale is a real estate agent, a potential buyer, a contractor, or some other person who is authorized to enter the property and is therefore authorized to be in the neighborhood. This may not always be the case, and this assumption poses a security risk to nearby neighbors.

What is needed is a secure means for permitting property visitors to gain access to real property without a real estate professional physically present on-site. The systems, methods, and devices disclosed herein enable a licensed real estate professional to remotely open a digital lockbox and enable a property visitor to gain access to the key and tour the real property. The disclosures herein include security features to ensure the property visitor can only open the digital lockbox with direct and secure access from a licensed real estate professional. This eliminates numerous inefficiencies in the real estate market while ensuring safety and security for the seller of the real property.

Before the structures, systems, and methods for remotely opening a digital lockbox are disclosed and described, it is to be understood that this disclosure is not limited to the particular structures, configurations, process steps, and materials disclosed herein as such structures, configurations, process steps, and materials may vary somewhat. It is also to be understood that the terminology employed herein is used for the purpose of describing particular embodiments only and is not intended to be limiting since the scope of the disclosure will be limited only by the appended claims and equivalents thereof.

In describing and claiming the subject matter of the disclosure, the following terminology will be used in accordance with the definitions set out below.

It must be noted that, as used in this specification and the appended claims, the singular forms “a,” “an,” and “the” include plural referents unless the context clearly dictates otherwise.

As used herein, the terms “comprising,” “including,” “containing,” “characterized by,” and grammatical equivalents thereof are inclusive or open-ended terms that do not exclude additional, unrecited elements or method steps.

As used herein, the phrase “consisting of” and grammatical equivalents thereof exclude any element or step not specified in the claim.

As used herein, the phrase “consisting essentially of” and grammatical equivalents thereof limit the scope of a claim to the specified materials or steps and those that do not materially affect the basic and novel characteristic or characteristics of the claimed disclosure.

Reference will now be made in detail to the exemplary embodiments, examples of which are illustrated in the accompanying drawings. Wherever possible, the same reference numbers are used throughout the drawings to refer to the same or like parts. It is further noted that elements disclosed with respect to embodiments are not restricted to only those embodiments in which they are described. For example, an element described in reference to one embodiment or figure, may be alternatively included in another embodiment or figure regardless of whether or not those elements are shown or described in another embodiment or figure. In other words, elements in the figures may be interchangeable between various embodiments disclosed herein, whether shown or not.

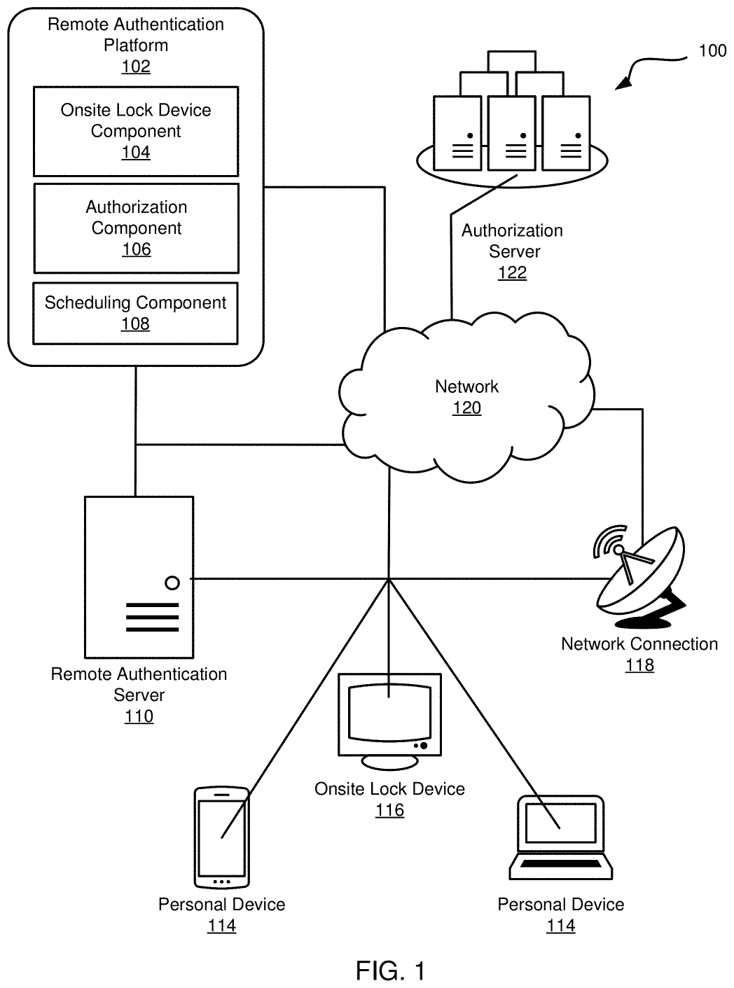

Referring now to the figures, FIG. 1 is a schematic diagram of a system 100 for facilitating communications between a remote authentication service and an onsite lock device such as a digital lockbox. The system 100 includes a remote authentication platform 102 in communication with a remote authentication server 110 and a network 120. Access to the network 120 may be provided onsite at a property, such as a residence, commercial building, land, or other real property, by way of a network connection 118 that may be connected with the remote authentication server and/or individual devices such as an onsite lock device 116 and/or a personal device 114.

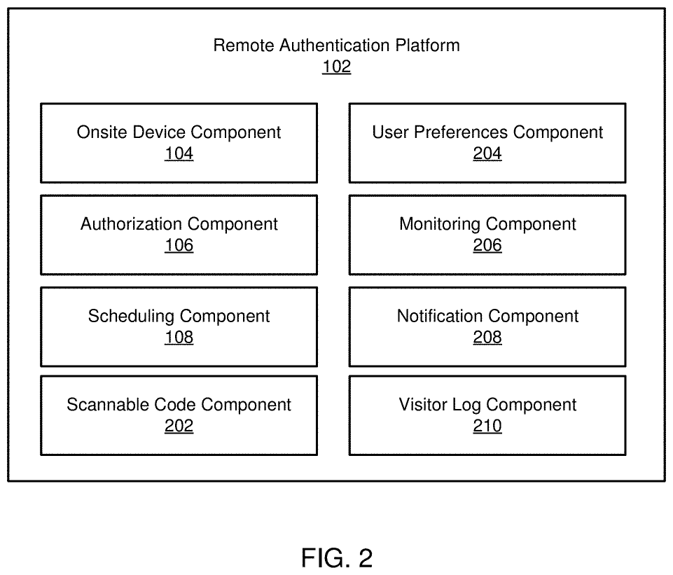

The remote authentication platform 102 includes one or more of an onsite lock device component 104, an authorization component 106, and a scheduling component 108. The remote authentication platform 102 may include further components and may be configured to perform additional instructions, for example according to the remote authentication platform 102 as discussed in FIG. 2. The remote authentication platform 102 can be accessed by way of an onsite lock device 116 that may be temporarily installed or permanently fixed at the property. The onsite lock device 116 may include a digital lockbox storing a key to enter the property, an automated door lock, a keyless door lock, or some other type of onsite lock device 116 as deemed appropriate. The remote authentication platform 102 may further be accessed by way of a personal device 114 such as a smart phone, a tablet, a laptop, a personal computer, and so forth.

The onsite lock device component 104 of the remote authentication platform 102 communicates with the onsite lock device 116 and provides instructions to the onsite lock device 116. In an embodiment, the onsite lock device 116 is a digital lockbox with a compartment for securely storing a key to the property. The onsite lock device 116 may be configured to open in response to receiving instructions from the remote authentication platform 102 indicating that a user has been authenticated and the onsite lock device 116 should open. The onsite lock device 116 may further be configured to open in response to receiving a passcode, scannable code, or other indication from a licensed real estate professional or other authorized person. The onsite lock device 116 may further be configured to store a timestamped log of all persons who have opened the onsite lock device 116 to retrieve the key to the property. In an embodiment, the onsite lock device 116 is in communication with the onsite lock device component 104 and provides an indication to the remote authentication platform 102 that an authorized or unauthorized person has retrieved the key to enter the property. In an embodiment, the onsite lock device component 104 triggers a notification to be sent to the property owner or other manager of the security system, indicating that an authorized or unauthorized person has retrieved the key from the onsite lock device 116 and has entered the property.

In an embodiment, the onsite lock device 116 is an automated door lock system or automated gate lock system. In this embodiment, the onsite lock device 116 receives instructions from the remote authentication server 110 to unlock in response to the remote authentication server 110 determining that an authorized user has requested to open the onsite lock device 116. The onsite lock device 116 may then open the door, unlock the deadbolt, unlock the gate, and so forth, depending on the application. The onsite lock device 116 may additionally include a camera, microphone, or speaker to provide two-way communication between the remote authentication platform 102 and a user that is physically present near the onsite lock device 116. The onsite lock device 116 may capture video and/or images of the user that requests access to the real property and then enters the real property. The video and/or images captured by the onsite lock device 116 may be transmitted to the remote authentication server 110 to be stored and later retrieved by an authorized individual.

In an embodiment, the onsite lock device 116 is one component is a home automation system, home security system, or other system that may include one or more of lockboxes, locks, deadbolts, window locks, cameras, microphones, motion sensors, and so forth. In this instance, the onsite lock device 116 may provide access to the property to an authorized user and may additionally track when the visitor entered and exited the property and may additionally track the visitor's whereabouts within the property.

In an embodiment, the onsite lock device component 104 provides access to transaction information such as who has entered the property, when they entered the property, how long they were at the property, video footage of the person(s) at the property, motion sensor data when the person(s) were at the property, whether the person armed the system upon leaving the property, and so forth.

The authorization component 106 of the remote authentication platform 102 provides access to the property after authorizing a person to enter the property. The authorization component 106 may receive an indication from the onsite lock device 116 that one or more persons are requesting authorization to enter the property. In an embodiment, a licensed real estate professional requests access to the property. In an alternative embodiment, a property visitor (such as a potential buyer, contractor, guest, client, builder, etc.) requests access to the property when a licensed real estate professional is not physically present at the property. In an embodiment where the licensed real estate professional requests access to the property, the licensed real estate professional may provide credentials, such as a login, a code, an identity badge, and so forth to indicate that the licensed real estate professional has permission to enter the property.

In an embodiment where the property visitor seeks access to the property without a licensed real estate professional physically present at the property, the authorization component 106 may coordinate with each of the property visitor who is located at the property and a licensed real estate professional who is not physically located at the property. The authorization component 106 may coordinate with the licensed real estate professional (who is remote from the property) to receive confirmation that the licensed real estate professional knows the property visitor and will sponsor the property visitor's tour of the property. In this embodiment, the authorization component 106 may provide the property visitor access to the property only after the authorization component 106 determines that (a) the property visitor is scheduled to view the property; (b) the real estate professional is licensed in the appropriate jurisdiction; and (c) the real estate professional is sponsoring the property visitor's tour of the property. The authorization component 106 may provide access for the property visitor to view the property only if the licensed real estate professional sponsor's the property visitor's visit in real-time when the property visitor is requesting access. In an alternative embodiment, the authorization component 106 may provide access to the property visitor based on a verified pre-authorization by the licensed real estate professional.

The authorization component 106 may authorize a person to enter the property independent of the onsite lock device 116. In an embodiment, the authorization component 106 is in communication with a code reader configured to scan a code indicating that a person is authorized to enter the property. In an embodiment, the authorization component 106 is in communication with a digital code-receiving device, such as a touch screen, a fingerprint sensor, a retina sensor, a keypad, and so forth, and the authorization component 106 may thereby receive an indication that a person has submitted a code as proof of authorization to enter the property.

The scheduling component 108 of the remote authentication platform 102 stores a listing of individuals who are authorized and/or registered to view the property. In an embodiment the seller of the property creates an account on the remote authentication platform 102. The seller of the property may decide whether property visitors are permitted to see the home without a licensed real estate professional physically present at the property. If the seller elects to allow property visitors to view the home unaccompanied by a real estate professional, then the seller may further approve and deny certain property visitors to view the home unaccompanied. Additionally, the seller may indicate whether the property visitor must be represented by a real estate professional who can provide remote authentication of real estate licensure when not physically present at the property. Alternatively, the seller may indicate that a property visitor may view the property even if the seller is not represented by a real estate professional, e.g., in a for sale by owner transaction wherein neither the buyer nor the seller is represented by a real estate agent.

The scheduling component 108 receives a request to schedule an appointment to view the property. The request may be received directly from a property visitor or may be received by a real estate professional who is representing the property visitor. The scheduling component 108 determines whether the property visitor is represented by a real estate professional. The scheduling component 108 verifies whether the real estate professional is lawfully licensed to sell real estate in the appropriate jurisdiction. The scheduling component 108 may access a database of licensed real estate agents, brokers, and salespersons, or may communicate with a third-party application that determines if the real estate professional possess the necessary licensure. The scheduling component 108 may present the appointment request to the seller of the home. The seller may indicate when the property visitor may see the home and whether the property visitor may see the property when the real estate professional is not physically present at the property.

The scheduling component 108 maintains a database of appointments to view the property. When a property visitor and/or real estate professional seeks to gain access to the property, the authorization component 106 communicates with the scheduling component 108 to determine whether the property visitor has an appointment to view the property, and whether the property visitor has arrived at the property within the appointment timeframe. The authorization component 106 may deny access to the property if the property visitor does not have an appointment or has approached the property outside the appointment timeframe.

The remote authentication server 110 provides access to the remote authentication platform 102 to onsite lock devices 116 and/or personal devices 114. The remote authentication server 110 may serve as a dedicated server group to support the remote authentication platform 102 for all devices (see 116, 114) interacting with the remote authentication platform 102.

The onsite lock device 116 is a device that is located onsite at the property. In an embodiment, the onsite lock device 116 is a digital lockbox comprising a compartment for storing a key to the property. In an embodiment, the digital lockbox is specifically programmed to open only for licensed real estate professionals such that licensed real estate professional can enter the property for a showing. In an embodiment, the digital lockbox is programmed to open for specific authorized individuals. In an embodiment, the digital lockbox is programmed to open in response to a remote request from a licensed real estate professional who is not physically present at the property. The digital lockbox may comprise a scanner for scanning any suitable code, such as a QR code or barcode generated by a computer application. In an embodiment, the computer application is processed by a personal device 114. The onsite lock device is in communication with the remote authentication platform 102 by way of the network 120 and can thereby receive an indication over the network 120 of the identity of persons who are authorized to enter the property.

In an embodiment, the onsite lock device 116 is an automated door lock configured to unlock a deadbolt and/or hand lock on a door in response to authenticating a user as having permission to enter a property. In an embodiment, the onsite lock device 116 is a keypad, touchpad, or scanner device connected to a locking mechanism of a door. In an embodiment, the onsite lock device 116 is configured to authenticate the identity of a person and/or determine whether the person is authorized to enter the property, and then unlock the property on the person's behalf. In such an embodiment, the property is unlocked for the authorized user without giving the authorized user access to a key to the property or requiring the authorized user to manually unlock the property. As discussed herein, a “digital lockbox” encompasses an automated door lock that can automatically unlock a door without providing a user access to a key to the property.

In an embodiment, the onsite lock device 116 is not actually located on the property but is a component part of an integrated network or cloud network security system where there may not be a physical device present at the property but instead a computer-based application may operate the system though the existing networks 120 utilizing a network connection 118 such as Wi-Fi or cellular connection. For example, in such an embodiment, a surveillance system may be in communication with a network and may have the ability to unlock a door or window or other entrance at the house. The onsite lock device 116 may constitute a communication with the surveillance system that enables an authorized person to enter the property. In such an embodiment, the connection may be installed and managed by the property owner or a security/surveillance monitoring entity.

The personal device 114 is any personal computing device that can communicate with the remote authentication server 110 and/or the onsite lock device 116. The personal device 114 may include a smart phone, a tablet, a laptop, a personal computer, and so forth. Personal devices 114 may communicate with the remote authentication server 110 by way of a local area network (LAN), wide area network (WAN), or another network connection. In an embodiment, personal devices 114 can connect to a network 120, such as a cloud computing network or the Internet, by way of a network connection 118 that may be facilitated by the remote authentication server 110.

The authorization server 122 may be located offsite at a location that is remote to the property. The authorization server 122 may include a log of persons who are authorized to enter the property. The log of persons who are authorized to enter the property may include, in one example implementation, all licensed real estate professionals within a region. The log of persons may include specific identified persons. The log of persons may include specific contractors, cleaners, managers, or other persons who are given permission to access the property. The log of persons may include friends, relatives, or neighbors who are authorized to enter the property. The log of persons may include an indication of specific dates, times, or durations of time that each of the persons is authorized to enter the property. In an embodiment, the log of persons indicates that all licensed real estate professionals within the region are authorized to enter the property, but only on certain days, at certain times, and/or for a defined duration of time.

The authorization server 122 may be in communication with a network 120 such as a cloud computing network. In an embodiment, the remote authentication server 110 is in communication with the authorization server 122 by way of the network 120 such that new profiles of authorized persons may be uploaded from the authorization server 122 to the remote authentication server 110. In an embodiment, a single server includes the information stored in the authorization server 122 and the remote authentication server 110. In an embodiment, the information stored in the authorization server 122 includes sensitive information such as personally identifiable information, and the information is therefore encrypted and safeguarded.

In an embodiment as illustrated in FIG. 1, the remote authentication server 110 is independent of the authorization server 122. This may be desirable in an instance where the remote authentication platform 102 connects to a third-party server or database that comprises user profile information for authorized persons. For example, a third-party service might exist that catalogs user profile information for numerous retail establishments. The remote authentication platform 102 may connect with such a third-party service to obtain user profile information. The remote authentication platform 102 may receive user profile information from a third-party user profile service by way of the authorization server 122.

In an embodiment (not shown in FIG. 1), the remote authentication server 110 and the authorization server 122 are not independent of one another. In such an embodiment, a single server group may include all information necessary for running the remote authentication platform 102, including user profile information, payment information, transaction history, and/or information specific to one or more retail establishments. It should be appreciated that numerous different configurations may be used without departing from the scope of the disclosure.

The network connection 118 provides users access to the network 120. The network 120 may include a cloud computing network, and/or the Internet, and/or part of a closed or private network. The network connection 118 may provide the remote authentication server 110 access to the network 120 and may further provide any of the onsite lock devices 116 and/or personal devices 114 access to the network 120.

FIG. 2 is a block diagram of the remote authentication platform 102. The remote authentication platform 102 includes the onsite lock device component 104, the authorization component 106, and the scheduling component 108 as discussed in FIG. 1. The remote authentication platform 102 may further include one or more of the scannable code component 202, the user preferences component 204, the monitoring component 206, the notification component 208, the visitor log component 210, and other components as deemed necessary based on the implementation.

For purposes of illustration, programs and other executable program components are shown herein as discrete blocks, although it is understood that such programs and components may reside at various times in different storage components of a computing device and are executed by one or more processors. Alternatively, the systems and procedures described herein can be implemented in hardware, or a combination of hardware, software, and/or firmware. For example, one or more application specific integrated circuits (ASICs) can be programmed to carry out one or more of the systems and procedures described herein. As used herein, the term “component” is intended to convey the implementation apparatus for accomplishing a process, such as by hardware, or a combination of hardware, software, and/or firmware, for the purposes of performing all or parts of operations disclosed herein. The terms “component” is intended to convey independence in how the modules, components, or their functionality or hardware may be implemented in different embodiments.

The scannable code component 202 stores information about a scannable code associated with a certain authorized person or account. When the scannable code is scanned by a component of the surveillance system itself and/or an onsite lock device 116, the remote authentication platform 102 can look up the appropriate authorized person or account. The remote authentication platform 102 can thereby independently determine whether the person is authorized to enter the property.

The user preferences component 204 stores information pertaining to a user's account with the remote authentication platform 102. The user preferences component 204 may store information about the property owner or property manager. In an embodiment, the user preferences component 204 stores information about when the property owner is typically home, when the property owner allows others to visit the property, contact information for the property owner, and so forth.

The monitoring component 206 is in communication with sensors at the property. The monitoring component 206 may estimate whether a person is present at the property based on data received from the sensors at the property. The monitoring component 206 may determine whether a person is currently at the property, where the person is within the property, and whether the authorized person brought guests to the property. In an embodiment, the monitoring component 206 is in communication with a deep neural network trained to determine whether a real estate professional is at the property with one or more prospective buyers. This determination may be made based on sensor data indicating, for example, how many people are at the property, where the persons are located within the property, and whether the persons appear to be behaving as prospective buyers touring the property.

The notification component 208 monitors notifications sent to the property owner and/or property manager, law enforcement officials, fire department officials, a monitoring agency or service, and so forth. In an embodiment, the notification component 208 notifies the property owner when an authorized person has entered the property and when the authorized person has departed the property. In an embodiment, the notification component 208 notifies the property owner when the alarm system has been disarmed or armed. In an embodiment, the notification component 208 provides a live video stream of an authorized person at the property, based on sensors in communication with the remote authentication platform 102.

The visitor log component 210 stores a timestamped log of authorized and/or unauthorized persons who have visited the property. The visitor log component 210 may store video and/or camera image footage in connection with log entries of when persons visited the property.

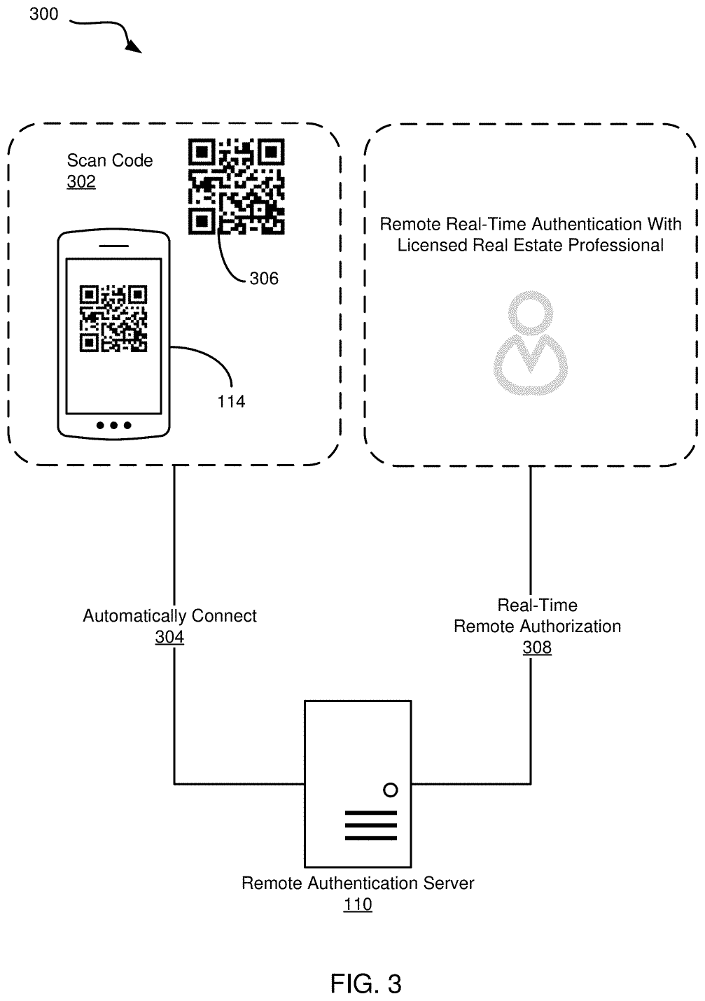

FIG. 3 is a schematic diagram of a system 300 for communicating with the remote authentication server 110 to authorize a person to gain access to a property by way of an onsite device 116. The seller of a property may require two-step authentication process illustrated in FIG. 3 when a property visitor seeks to visit the property unaccompanied by a licensed real estate professional. The two-step authentication process includes authentication of the property visitor with the scannable code 306 and further includes remote real-time authentication with the property visitor's licensed real estate professional.

The property visitor is provided with a scannable code 306 indicating that the property visitor has permission to enter the property. The scannable code 306 may indicate that the property visitor is authorized to enter the property only at a certain date and time. In an embodiment, the property visitor receives the scannable code 306 only after the person's identity has been authenticated by the authorization component 106 and the seller of the property has agreed to allow the person to enter the property.

The licensed real estate professional communicates real-time remote authorization 308 with the remote authentication server 110 when the property visitor seeks to enter the property. The real estate indicates in real-time that the property visitor is a legitimate client seeking to view the property. The seller of the property may be more comfortable allowing the unaccompanied property visitor to enter the property because the real estate professionals validates the identity of the property visitor in real-time. In an embodiment, the remote authentication server 110 will not cause the onsite lock device 116 to open until the property visitor presents the correct scannable code 306 at the onsite lock device 116 and the real estate professional validates that identity of the property visitor in real-time.

In an embodiment, the property visitor scans the code 302 by presenting the scannable code 306 to a sensor on the onsite lock device 116 and/or a personal device 114 and/or a code scanner integrated with the remote authentication platform 102. The onsite lock device 116 automatically connects 304 with the remote authentication server 110 in response to reading the scannable code 306. In alternative embodiments, the property visitor does not present a scannable code 306 and instead presents a numeric password, an alphanumeric password, a fingerprint scan, a retina scan, a key, a unique code, an authentication by way of an authentication application, and so forth.

The scannable code 306 may be any scannable figure or code that is readable by a device, such as a digital lockbox or other code reader. In an embodiment, the scannable code 306 is a two-dimensional barcode such as a quick response (QR) code. The two-dimensional barcode can be digitally scanned by a camera or other sensor on the onsite lock device 116 and/or personal device 114. In an embodiment, the scannable code 306 is designed to appear like a graphic or image and the two-dimensional barcode is integrated or “hidden” in the image. The scannable code 306 may include multiple squares that can be read by the image sensor of the personal device 114. In an embodiment, the scannable code 306 is presented on the screen of a personal device such as a mobile phone.

In an embodiment where the scannable code 306 is a QR code, the code includes three large squares (the three large squares can be seen in the upper-left, lower-left, and upper-right corners of the example scannable code 306 shown in FIG. 3) that serve as alignment targets while a smaller square in a remaining corner of the scannable code 306 (the smaller square can be seen near the lower-right corner of the example scannable code 306 shown in FIG. 3) serves to normalize the angle with which the image sensor hits the scannable code 306. The remaining area of the scannable code 306 is the actual data that is converted into binary code by the personal device 114. The scannable code 306 may include many characters worth of data. In an example where the scannable code 306 is a 117-pixel square, the code may hold 1852 characters of data.

In an embodiment, an image sensor of the onsite lock device 116 and/or personal device 114 is directed to scan the scannable code 306, and the scannable code 306 includes instructions for the onsite lock device 116 and/or personal device 114 to connect to the remote authentication server 110. A processor of the onsite lock device 116 and/or personal device 114 may execute the instructions stored in the scannable code 306 to automatically connect 304 to the remote authentication server 110.

The real-time remote authorization 308 may be initiated by the property visitor, the real estate professional, or the remote authentication server 110. In an embodiment, the property visitor presents the scannable code 306 to the onsite lock device 116 and this causes the onsite lock device 116 to communicate with the remote authentication server 110 and look up the property visitor's profile. The remote authentication server 110 determines the identity of the property visitor and whether the property visitor is authorized to view the property based on the scannable code 306. The remote authentication server 110 determines if a real estate professional is associated with the property visitor. In response to determining that the property visitor is represented by a real estate professional, the remote authentication server 110 notifies the appropriate real estate professional that the property visitor is on-site at the property and wishes to gain access to the property. The remote authentication server 110 request real-time remote authorization 308 from the real estate professional indicating that (a) the property visitor is a legitimate client represented by the real estate professional; (b) the real estate professional will sponsor the property visitor's viewing of the property; and/or (c) the property visitor should be granted access to the property.

The remote authentication server may provide identifying information to the real estate professional to assist the real estate professional in authenticating the identity of the property visitor. This may include the name of the property visitor, a unique code or password associated with the property visitor, an image or video stream of the property visitor at the property, and so forth. The real estate professional may view this information by way of the remote authentication platform 102.

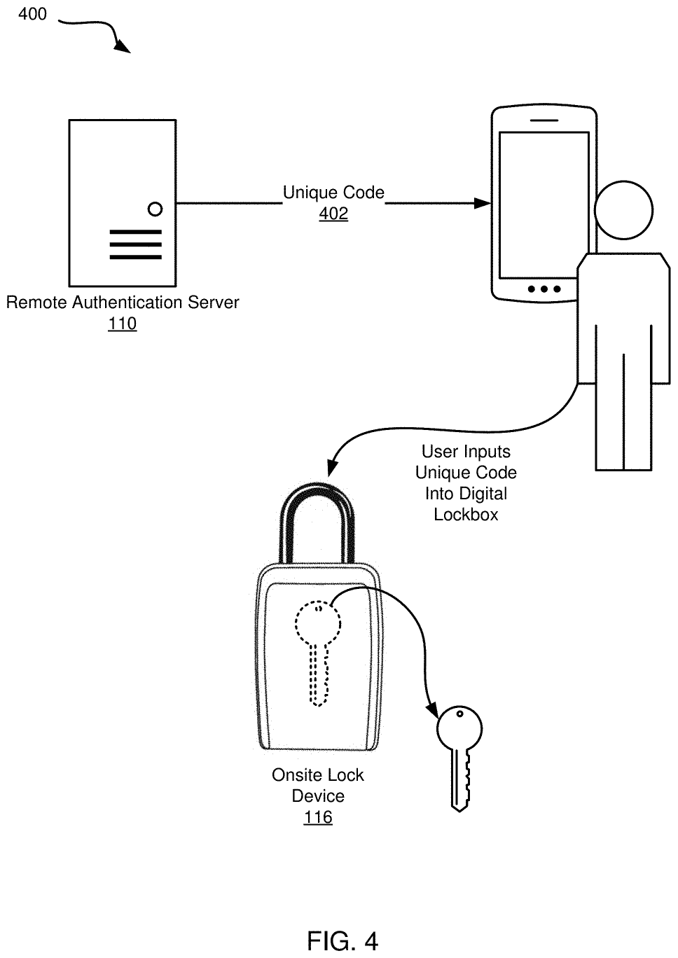

FIG. 4 is a schematic diagram of a system 400 for remote authentication of a property visitor seeking to view a property. In the system 400 illustrated in FIG. 4, the remote authentication server 110 provides a unique code 402 to the property visitor. The unique code 402 may be sent to a mobile device associated with the property visitor by way of text message, email, authentication application, or some other secure means of communication. The property visitor may then input the unique code 402 into the onsite lock device 116 to gain access to the property.

In an embodiment, the remote authentication server 110 provides the unique code 402 to the property visitor only after the property visitor agrees to the terms and conditions of remote authentication and any additional terms and conditions set by the seller of the property. The unique code 402 may be a one-time code that will unlock the onsite lock device 116 only one time. If any person attempts to unlock the onsite lock device 116 with the unique code 402 a subsequent time, the onsite lock device 116 will return an error and refuse to open. The unique code 402 may be time-sensitive such that the onsite lock device 116 will open in response to receiving the unique code 402 only within a specified timeframe. The specified timeframe may be the appointment window assigned to the property visitor. The specified timeframe may be a period of time beginning when the unique code 402 was transmitted to the user. For example, the unique code 402 may be transmitted to the user and may be valid for only a specified duration of time, for example, 15 minutes, 30 minutes, one hour, and so forth.

In an embodiment, the real estate professional sends the unique code 402 to the property visitor. The real estate professional may receive the unique code 402 from the remote authentication server 110 and then forward to the unique code 402 to the property visitor. The real estate professional may notify the remote authentication server 110 that a unique code 402 should be sent to the property visitor, and then the remote authentication server 110 generates the unique code 402 and sends the unique code 402 to the property visitor.

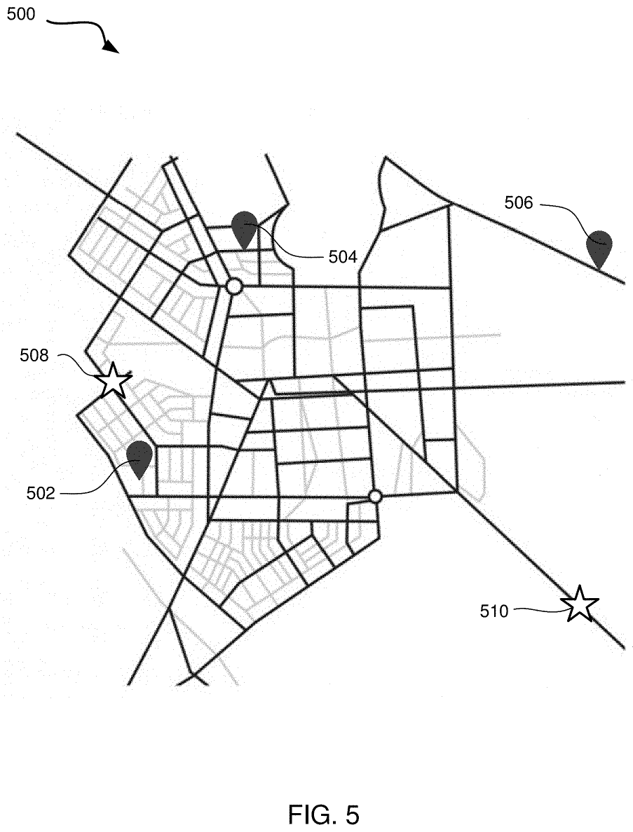

FIG. 5 illustrates mapping diagram 500 for generating a most efficient route for viewing real property. The mapping diagram 500 illustrated in FIG. 5 includes three destinations, including destination A 502, destination B 504, and destination C 506. The mapping diagram 500 further includes two starting positions, including starting position D 508, and starting position E 510. In a common implementation, one of the starting positions is associated with the property visitor of real property and the other starting position is associated with the real estate professional who will be accompanying the property visitor to see the properties 502-506. It should be appreciated that the mapping diagram 500 may have any suitable number of destinations and any suitable number of starting positions.

In an embodiment, the systems described herein generate a most efficient route for touring the properties 502-506. The most efficient route has the lowest cost based on one or more of travel time, distance traveled, and likelihood of encountering traffic. When two or more starting positions 508, 510 are applicable to determining the most efficient route (e.g., when two or more people will be viewing the properties 502-506 beginning at different locations), one of the two starting positions may be weighted more heavily when calculating the most efficient route. For example, a real estate professional may select to weight the property visitor's starting position more heavily such that the home viewing process is quicker and more efficient for the property visitor.

The most efficient route includes a stop at each of the properties 502-506. The first destination will be the same for each of the one or more starting positions. For example, if the property visitor is beginning at starting position D and the real estate professional is beginning at starting position E, each of the property visitor and the real estate professional will be directed to meet up at the same first destination (i.e., one of destination A 502, destination B 504, or destination C 506). This will ensure that the property visitor and the real estate professional will tour the homes at the same time. The route to the subsequent destinations may be the same for each party or may be different for each party depending on the parties' preferences. For example, if a first user wishes to prioritize travel time over distance traveled, and a second user wishes to prioritize distance traveled over travel time, then the route from a first destination to a second destination may be different for the first user and the second user.

The most efficient route includes a stop at each of the destinations 502-506. The most efficient route will select the order of the destinations based on the location of each destination relative to one another and relative to the one or more starting positions. The most efficient route will be the lowest cost route based on one or more of travel time, distance traveled, or likelihood of encountering traffic.

The most efficient route is additionally based on potential scheduling requirements or conflicts at each of the one or more destinations. For example, the seller of the real property at destination A may provide a length time window for viewing the real property. Alternatively, the seller of the real property at destination B may provide a short or precise time window for viewing the real property. Further for example, the parties traversing the route may indicate a start time and a finish time for completing the entire route and/or for viewing one or more properties within the route. The most efficient route is determined based on these scheduling constraints such that each property will be seen within the approved time window and each property will be seen within the window defined by the start time and finish time for completing the entire route.

The most efficient route may additionally include a time schedule for viewing each of the properties. For example, the most efficient route may provide a start time for leaving each of starting position D 508 and starting position E 510. The start time may be different for the multiple starting positions and is based on the predicted time for traveling from the starting position to the first destination while factoring in predicted traffic. The most efficient route may provide a predicted arrival time at the first destination and a predicted time spent at the first destination before proceeding to the second destination. The most efficient route may provide a travel time estimate and an arrival time estimate for each destination within the route. Again, the time schedule for the most efficient route may be determined such that each property is seen within the allowed time frame.

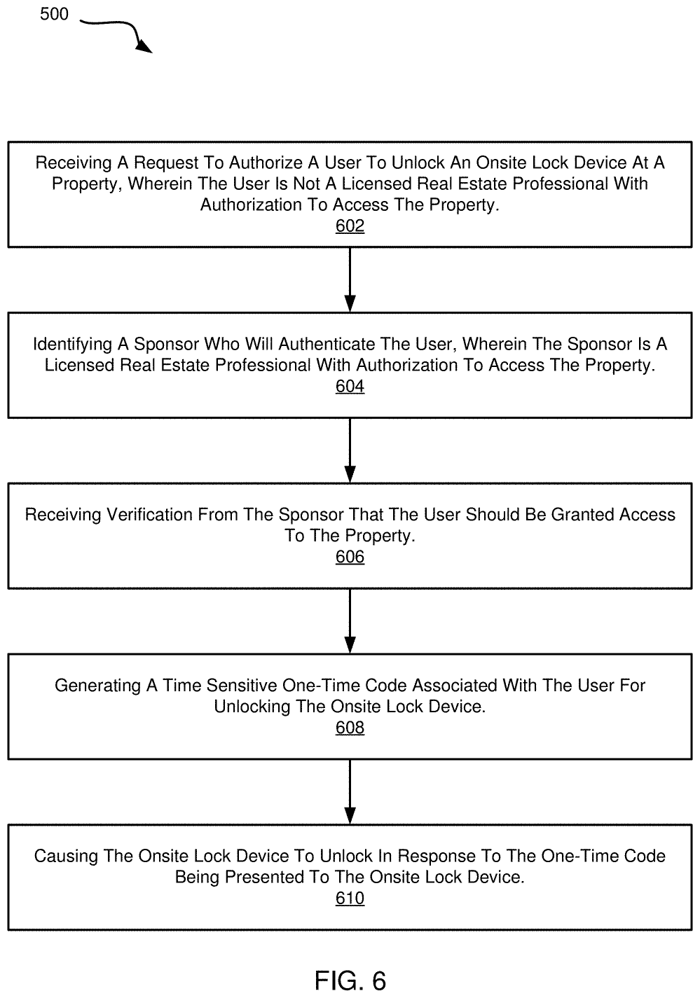

FIG. 6 is a schematic diagram of a method 600 for remote authorization for unlocking an onsite lock device. The method 600 begins and a computing resource receives at 602 a request to authorize a user to unlock an onsite lock device at a property, wherein the user is not a licensed real estate professional with authorization to access the property. The computing resource receiving the request at 602 may include a server or other computing in communication with the onsite lock device and/or may include a computer embedded in the onsite lock device itself. The method 600 continues and a computing resource identifies at 604 a sponsor who will authenticate the user, wherein the sponsor is a licensed real estate professional with authorization to access the property. The method 600 continues and a computing resource receives at 606 verification from the sponsor that the user should be granted access to the property. The method 600 continues and a computing resource generates at 608 a time sensitive one-time code associated with the user for unlocking the onsite lock device. The method 600 continues and a computing resource causes at 610 the onsite lock device to unlock in response to the one-time code being presented to the onsite lock device.

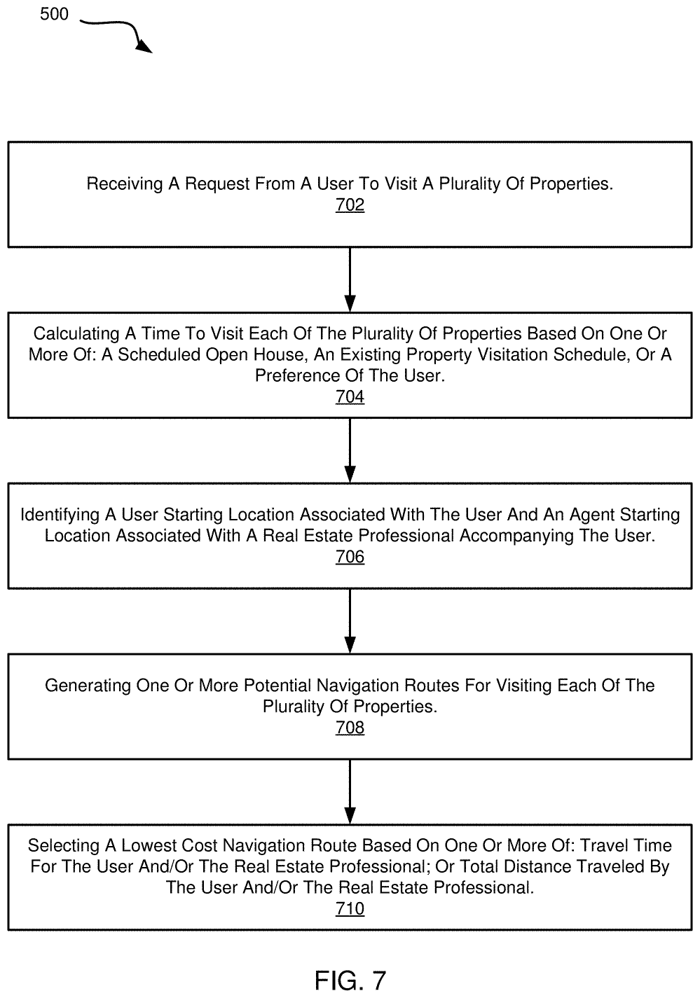

FIG. 7 is a schematic diagram of a method 700 for generating an efficient navigation route. The method 700 begins and a computing resource receives at 702 a request from a user to visit a plurality of properties. The method 700 includes a computing resource calculating at 704 a time to visit each of the plurality of properties based on one or more of: a scheduled open house for any of the plurality of properties, an existing property visitation schedule for any of the plurality of properties, or a preference of the user. The method 700 includes a computing resource identifying at 706 a user starting location associated with the user and an agent starting location associated with a real estate professional accompanying the user. The method 700 includes a computing resource generating at 708 one or more potential navigation routes for visiting each of the plurality of properties. The method 700 includes a computing resource selecting at 710 a lowest cost navigation route based on one or more of: travel time for the user and/or the real estate professional, or total distance traveled by the user and/or the real estate professional.

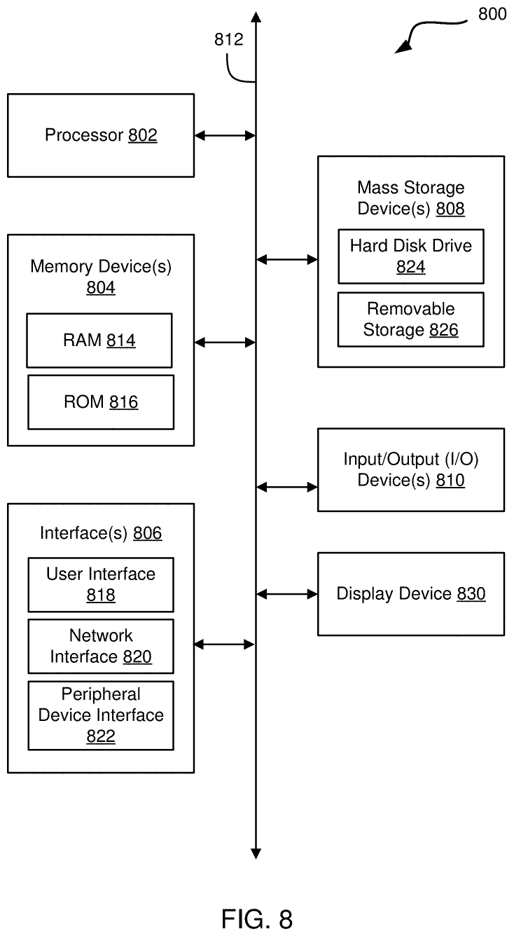

Referring now to FIG. 8, a block diagram of an example computing device 800 is illustrated. Computing device 800 may be used to perform various procedures, such as those discussed herein. Computing device 800 can perform various monitoring functions as discussed herein, and can execute one or more application programs, such as the application programs or functionality described herein. Computing device 800 can be any of a wide variety of computing devices, such as a desktop computer, in-dash computer, vehicle control system, a notebook computer, a server computer, a handheld computer, tablet computer and the like.

Computing device 800 includes one or more processor(s) 804, one or more memory device(s) 804, one or more interface(s) 806, one or more mass storage device(s) 808, one or more Input/output (I/O) device(s) 810, and a display device 830 all of which are coupled to a bus 812. Processor(s) 804 include one or more processors or controllers that execute instructions stored in memory device(s) 804 and/or mass storage device(s) 808. Processor(s) 804 may also include various types of computer-readable media, such as cache memory.

Memory device(s) 804 include various computer-readable media, such as volatile memory (e.g., random access memory (RAM) 814) and/or nonvolatile memory (e.g., read-only memory (ROM) 816). Memory device(s) 804 may also include rewritable ROM, such as Flash memory.

Mass storage device(s) 808 include various computer readable media, such as magnetic tapes, magnetic disks, optical disks, solid-state memory (e.g., Flash memory), and so forth. As shown in FIG. 8, a particular mass storage device 808 is a hard disk drive 824. Various drives may also be included in mass storage device(s) 808 to enable reading from and/or writing to the various computer readable media. Mass storage device(s) 808 include removable media 826 and/or non-removable media.

I/O device(s) 810 include various devices that allow data and/or other information to be input to or retrieved from computing device 800. Example I/O device(s) 810 include cursor control devices, keyboards, keypads, microphones, monitors or other display devices, speakers, printers, network interface cards, modems, and the like.

Display device 830 includes any type of device capable of displaying information to one or more users of computing device 800. Examples of display device 830 include a monitor, display terminal, video projection device, and the like.

Interface(s) 806 include various interfaces that allow computing device 800 to interact with other systems, devices, or computing environments. Example interface(s) 806 may include any number of different network interfaces 820, such as interfaces to local area networks (LANs), wide area networks (WANs), wireless networks, and the Internet. Other interface(s) include user interface 818 and peripheral device interface 822. The interface(s) 806 may also include one or more user interface elements 818. The interface(s) 806 may also include one or more peripheral interfaces such as interfaces for printers, pointing devices (mice, track pad, or any suitable user interface now known to those of ordinary skill in the field, or later discovered), keyboards, and the like.

Bus 812 allows processor(s) 804, memory device(s) 804, interface(s) 806, mass storage device(s) 808, and I/O device(s) 810 to communicate with one another, as well as other devices or components coupled to bus 812. Bus 812 represents one or more of several types of bus structures, such as a system bus, PCI bus, IEEE bus, USB bus, and so forth.

### EXAMPLES

The following examples pertain to further embodiments.

Example 1 is a method. The method includes receiving a request to authorize a user to unlock an onsite lock device at a property, wherein the user is not a licensed real estate professional with authorization to access the property. The method includes identifying a sponsor who will authenticate the user, wherein the sponsor is a licensed real estate professional with authorization to access the property. The method includes receiving verification from the sponsor that the user should be granted access to the property. The method includes generating a time sensitive one-time code associated with the user for unlocking the onsite lock device. The method includes causing the onsite lock device to unlock in response to the one-time code being presented to the onsite lock device.

Example 2 is a method as in Example 1, wherein the one-time code comprises an electronic code displayed as an image, and wherein the onsite lock device comprises an image sensor for reading the electronic code.

Example 3 is a method as in any of Examples 1-2, wherein causing the onsite lock device to unlock comprises communicating with the onsite lock device over a network and providing data to the onsite lock device, wherein the data comprises one or more of: the one-time code, an identity of the user associated with the one-time code, and a timeframe wherein the one-time code is valid to the onsite lock device.

Example 4 is a method as in any of Examples 1-3, further comprising, in response to the onsite lock device unlocking in response to the one-time code, storing a log entry comprising one or more of: a timestamp when the one-time code was presented to the onsite lock device; an identity of the user associated with the one-time code; and a timestamp when the onsite lock device was unlocked.

Example 5 is a method as in any of Examples 1-4, wherein generating the time sensitive one-time code comprises generating a numeric code, and wherein the method further comprises: transmitting the numeric code to a mobile phone number associated with the user; and transmitting the numeric code to the onsite lock device with an indication of a time period when the numeric code is valid.

Example 6 is a method as in any of Examples 1-5, wherein receiving the request to authorize the user comprises receiving the request when the user is located at the property, and wherein the method further comprises: receiving image data from an image sensor located at the property when the user is located at the property; providing the image data to the sponsor for verifying an identify of the user; and requesting remote verification from the sponsor whether the user should be granted access to the property based on the image data.

Example 7 is a method as in any of Examples 1-6, further comprising: receiving an image of the user in connection with the request to authorize the user to unlock the onsite lock device; receiving real-time image data from an image sensor located at the property when the user is located at the property; providing the image of the user and the real-time image data to a neural network trained to recognize whether the image of the user and the real-time image data comprise the same person; and causing the onsite lock device to unlock in response to receiving an indication from the neural network that the image of the user and the real-time image data comprise the same person.

Example 8 is a method as in any of Examples 1-7, further comprising authenticating the sponsor as a licensed real estate professional in a jurisdiction comprising the property by: identifying the jurisdiction comprising the property based on an address of the property; and querying a database comprising licensure information for real estate professionals in the jurisdiction comprising the property.

Example 9 is a method as in any of Examples 1-8, further comprising providing the time sensitive one-time code to the user by way of one or more of a text message sent to a mobile phone associated with the user or an authentication request for an authentication application associated with the user.

Example 10 is a method as in any of Examples 1-9, wherein the onsite lock device comprises one or more of an electronic lockbox storing a key to the property an electronic lock for opening an entryway to the property.

Example 11 is a method. The method includes receiving a request from a user to visit a plurality of properties. The method includes calculating a time to visit each of the plurality of properties based on one or more of: a scheduled open house, an existing property visitation schedule; or a preference of the user. The method includes identifying a user starting location associated with the user and an agent starting location associated with a real estate professional accompanying the user. The method includes generating one or more potential navigation routes for visiting each of the plurality of properties. The method includes selecting a lowest cost navigation route based on one or more of: travel time for the user and/or the real estate professional; or total distance traveled by the user and/or the real estate professional.

Example 12 is a method as in Example 11, wherein generating the one or more potential navigation routes comprises: calculating a plurality of ordering possibilities for the plurality of properties by reordering the plurality of properties; and generating a unique navigation route for each of the plurality of ordering possibilities.

Example 13 is a method as in any of Examples 11-12, wherein generating the one or more potential navigation routes comprises: calculating an ordering for visiting the plurality of properties identifying a first property to be visited and order for all subsequent properties to be visited; calculating user navigation route from the user starting location to the first property; and calculating an agent navigation route from the agent starting location to the first property.

Example 14 is a method as in any of Examples 11-13, wherein one or more of: identifying the user starting location comprises receiving positioning data from a Global Positioning System (GPS) associated with the user; or identifying the agent starting location comprises receiving data from a GPS associated with the real estate professional accompanying the user.

Example 15 is a method as in any of Examples 11-14, wherein selecting the lowest cost navigation route further comprises weighting the one or more potential navigation routes based on a preference for reducing travel time for the user, reducing travel time for the real estate professional, reducing total distance traveled by the user, or reducing total distance traveled by the real estate professional.

Example 16 is a method as in any of Examples 11-15, further comprising: communicating the request from the user to a scheduling contact for each of the plurality of properties; and identifying one or more available times for the user to visit each of the plurality of properties.

Example 17 is a method as in any of Examples 11-16, further comprising creating a property viewing timeframe for visiting each of the plurality of properties in succession.

Example 18 is a method as in any of Examples 11-17, wherein selecting the lowest cost navigation route comprises selecting based on predicted traffic conditions during the property viewing timeframe.

Example 19 is a method as in any of Examples 11-18, further comprising contacting the scheduling contact for each of the plurality of properties to pre-register the user to visit each of the plurality of properties during the property viewing timeframe.

Example 20 is a method as in any of Examples 11-19, further comprising generating a property viewing timeline comprising: an indication of a start time for the user to leave the user starting location to arrive at a first location at a preregistered time when the user is preregistered to view the first property; and an indication of a start time for the real estate professional accompanying the user to leave the agent starting location to arrive at the first location at the preregistered time.

Example 21 is a system comprising one or more processors for executing instructions, wherein the instructions comprise any of the method steps recited in any of Examples 1-20.

Example 22 is non-transitory computer readable storage medium storing instructions for execution by one or more processors, wherein the instructions comprise any of the method steps recited in any of Examples 1-20.

In the above disclosure, reference has been made to the accompanying drawings, which form a part hereof, and in which is shown by way of illustration specific implementations in which the disclosure may be practiced. It is understood that other implementations may be utilized, and structural changes may be made without departing from the scope of the present disclosure. References in the specification to “one embodiment,” “an embodiment,” “an example embodiment,” etc., indicate that the embodiment described may include a particular feature, structure, or characteristic, but every embodiment may not necessarily include the particular feature, structure, or characteristic. Moreover, such phrases are not necessarily referring to the same embodiment. Further, when a particular feature, structure, or characteristic is described in connection with an embodiment, it is submitted that it is within the knowledge of one skilled in the art to affect such feature, structure, or characteristic in connection with other embodiments whether or not explicitly described.

Implementations of the systems, devices, and methods disclosed herein may comprise or utilize a special purpose or general-purpose computer including computer hardware, such as, for example, one or more processors and system memory, as discussed herein. Implementations within the scope of the present disclosure may also include physical and other computer-readable media for carrying or storing computer-executable instructions and/or data structures. Such computer-readable media can be any available media that can be accessed by a general purpose or special purpose computer system. Computer-readable media that store computer-executable instructions are computer storage media (devices). Computer-readable media that carry computer-executable instructions are transmission media. Thus, by way of example, and not limitation, implementations of the disclosure can comprise at least two distinctly different kinds of computer-readable media: computer storage media (devices) and transmission media.

Computer storage media (devices) includes RAM, ROM, EEPROM, CD-ROM, solid state drives (“SSDs”) (e.g., based on RAM), Flash memory, phase-change memory (“PCM”), other types of memory, other optical disk storage, magnetic disk storage or other magnetic storage devices, or any other medium, which can be used to store desired program code means in the form of computer-executable instructions or data structures and which can be accessed by a general purpose or special purpose computer.

An implementation of the devices, systems, and methods disclosed herein may communicate over a computer network. A “network” is defined as one or more data links that enable the transport of electronic data between computer systems and/or modules and/or other electronic devices. When information is transferred or provided over a network or another communications connection (either hardwired, wireless, or a combination of hardwired or wireless) to a computer, the computer properly views the connection as a transmission medium. Transmissions media can include a network and/or data links, which can be used to carry desired program code means in the form of computer-executable instructions or data structures and which can be accessed by a general purpose or special purpose computer. Combinations of the above should also be included within the scope of computer-readable media.

Computer-executable instructions comprise, for example, instructions and data which, when executed at a processor, cause a general-purpose computer, special purpose computer, or special purpose processing device to perform a certain function or group of functions. The computer executable instructions may be, for example, binaries, intermediate format instructions such as assembly language, or even source code. Although the subject matter has been described in language specific to structural features and/or methodological acts, it is to be understood that the subject matter defined in the appended claims is not necessarily limited to the described features or acts described above. Rather, the described features and acts are disclosed as example forms of implementing the claims.

Those skilled in the art will appreciate that the disclosure may be practiced in network computing environments with many types of computer system configurations, including, an in-dash vehicle computer, personal computers, desktop computers, laptop computers, message processors, hand-held devices, multi-processor systems, microprocessor-based or programmable consumer electronics, network PCs, minicomputers, mainframe computers, mobile telephones, PDAs, tablets, pagers, routers, switches, various storage devices, televisions, and the like. The disclosure may also be practiced in distributed system environments where local and remote computer systems, which are linked (either by hardwired data links, wireless data links, or by a combination of hardwired and wireless data links) through a network, both perform tasks. In a distributed system environment, program modules may be located in both local and remote memory storage devices.

Further, where appropriate, functions described herein can be performed in one or more of: hardware, software, firmware, digital components, or analog components. For example, one or more application specific integrated circuits (ASICs) can be programmed to carry out one or more of the systems and procedures described herein. Certain terms are used throughout the description and claims to refer to particular system components. The terms “modules” and “components” are used in the names of certain components to reflect their implementation independence in software, hardware, circuitry, sensors, or the like. As one skilled in the art will appreciate, components may be referred to by different names. This document does not intend to distinguish between components that differ in name, but not function.

It should be noted that the sensor embodiments discussed above may comprise computer hardware, software, firmware, or any combination thereof to perform at least a portion of their functions. For example, a sensor may include computer code configured to be executed in one or more processors and may include hardware logic/electrical circuitry controlled by the computer code. These example devices are provided herein purposes of illustration and are not intended to be limiting. Embodiments of the present disclosure may be implemented in further types of devices, as would be known to persons skilled in the relevant art(s).

At least some embodiments of the disclosure have been directed to computer program products comprising such logic (e.g., in the form of software) stored on any computer useable medium. Such software, when executed in one or more data processing devices, causes a device to operate as described herein.

While various embodiments of the present disclosure have been described above, it should be understood that they have been presented by way of example only, and not limitation. It will be apparent to persons skilled in the relevant art that various changes in form and detail can be made therein without departing from the spirit and scope of the disclosure. Thus, the breadth and scope of the present disclosure should not be limited by any of the above-described exemplary embodiments but should be defined only in accordance with the following claims and their equivalents. The foregoing description has been presented for the purposes of illustration and description. It is not intended to be exhaustive or to limit the disclosure to the precise form disclosed. Many modifications and variations are possible in light of the above teaching. Further, it should be noted that any or all of the aforementioned alternate implementations may be used in any combination desired to form additional hybrid implementations of the disclosure.

Further, although specific implementations of the disclosure have been described and illustrated, the disclosure is not to be limited to the specific forms or arrangements of parts so described and illustrated. The scope of the disclosure is to be defined by the claims appended hereto, any future claims submitted here and in different applications, and their equivalents.

What is claimed is:

1. A method comprising:
receiving a request from a user to visit a plurality of properties;
calculating a time to visit each of the plurality of properties based on one or more of: a scheduled open house, an existing property visitation schedule; or a preference of the user;
identifying a user starting location associated with the user and an agent starting location associated with a real estate professional accompanying the user;
generating one or more potential navigation routes for visiting each of the plurality of properties; and
selecting a lowest cost navigation route based on one or more of: travel time for the user and/or the real estate professional; or total distance traveled by the user and/or the real estate professional.

2. The method of claim 1, wherein generating the one or more potential navigation routes comprises:
calculating a plurality of ordering possibilities for the plurality of properties by reordering the plurality of properties; and
generating a unique navigation route for each of the plurality of ordering possibilities.

3. The method of claim 1, wherein generating the one or more potential navigation routes comprises:
calculating an ordering for visiting the plurality of properties identifying a first property to be visited and order for all subsequent properties to be visited;
calculating user navigation route from the user starting location to the first property; and
calculating an agent navigation route from the agent starting location to the first property.

4. The method of claim 1, wherein one or more of:
identifying the user starting location comprises receiving positioning data from a Global Positioning System (GPS) associated with the user; or
identifying the agent starting location comprises receiving data from a GPS associated with the real estate professional accompanying the user.

5. The method of claim 1, wherein selecting the lowest cost navigation route further comprises weighting the one or more potential navigation routes based on a preference for reducing travel time for the user, reducing travel time for the real estate professional, reducing total distance traveled by the user, or reducing total distance traveled by the real estate professional.

6. The method of claim 1, further comprising:
communicating the request from the user to a scheduling contact for each of the plurality of properties; and
identifying one or more available times for the user to visit each of the plurality of properties.

7. The method of claim 6, further comprising creating a property viewing timeframe for visiting each of the plurality of properties in succession.

8. The method of claim 7, wherein selecting the lowest cost navigation route comprises selecting based on predicted traffic conditions during the property viewing timeframe.

9. The method of claim 7, further comprising contacting the scheduling contact for each of the plurality of properties to pre-register the user to visit each of the plurality of properties during the property viewing timeframe.

10. The method of claim 1, further comprising generating a property viewing timeline comprising:
an indication of a start time for the user to leave the user starting location to arrive at a first location at a preregistered time when the user is preregistered to view the first property; and
an indication of a start time for the real estate professional accompanying the user to leave the agent starting location to arrive at the first location at the preregistered time.

11. A system comprising one or more processors for executing instructions stored in non-transitory computer readable storage media, the instructions comprising:
receiving a request from a user to visit a plurality of properties;
calculating a time to visit each of the plurality of properties based on one or more of: a scheduled open house, an existing property visitation schedule; or a preference of the user;
identifying a user starting location associated with the user and an agent starting location associated with a real estate professional accompanying the user;
generating one or more potential navigation routes for visiting each of the plurality of properties; and
selecting a lowest cost navigation route based on one or more of: travel time for the user and/or the real estate professional; or total distance traveled by the user and/or the real estate professional.

12. The system of claim 11, wherein the instructions are such that generating the one or more potential navigation routes comprises:
calculating a plurality of ordering possibilities for the plurality of properties by reordering the plurality of properties; and
generating a unique navigation route for each of the plurality of ordering possibilities.

13. The system of claim 11, wherein the instructions are such that generating the one or more potential navigation routes comprises:
calculating an ordering for visiting the plurality of properties identifying a first property to be visited and order for all subsequent properties to be visited;
calculating user navigation route from the user starting location to the first property; and
calculating an agent navigation route from the agent starting location to the first property.

14. The system of claim 11, wherein the instructions are such that one or more of:
identifying the user starting location comprises receiving positioning data from a Global Positioning System (GPS) associated with the user; or
identifying the agent starting location comprises receiving data from a GPS associated with the real estate professional accompanying the user.

15. The system of claim 11, wherein the instructions are such that selecting the lowest cost navigation route further comprises weighting the one or more potential navigation routes based on a preference for reducing travel time for the user, reducing travel time for the real estate professional, reducing total distance traveled by the user, or reducing total distance traveled by the real estate professional.

16. Non-transitory computer readable storage media storing instructions for execution by one or more processors, the instructions comprising:
receiving a request from a user to visit a plurality of properties;
calculating a time to visit each of the plurality of properties based on one or more of: a scheduled open house, an existing property visitation schedule; or a preference of the user;
identifying a user starting location associated with the user and an agent starting location associated with a real estate professional accompanying the user;
generating one or more potential navigation routes for visiting each of the plurality of properties; and
selecting a lowest cost navigation route based on one or more of: travel time for the user and/or the real estate professional; or total distance traveled by the user and/or the real estate professional.

17. The non-transitory computer readable storage media of claim 16, wherein the instructions further comprise:
communicating the request from the user to a scheduling contact for each of the plurality of properties; and
identifying one or more available times for the user to visit each of the plurality of properties.

18. The non-transitory computer readable storage media of claim 17, wherein the instructions further comprise creating a property viewing timeframe for visiting each of the plurality of properties in succession.

19. The non-transitory computer readable storage media of claim 18, wherein the instructions further comprise contacting the scheduling contact for each of the plurality of properties to pre-register the user to visit each of the plurality of properties during the property viewing timeframe.

20. The non-transitory computer readable storage media of claim 18, wherein the instructions are such that selecting the lowest cost navigation route comprises selecting based on predicted traffic conditions during the property viewing timeframe.
